(19) United States
(12) Patent Application Publication
(10) Pub. No.: US 2015/0174800 A1
(43) Pub. Date: Jun. 25, 2015

(54) RESIN MOLDING METHOD AND LIQUID EJECTION HEAD MANUFACTURING METHOD

(71) Applicant: CANON KABUSHIKI KAISHA, Tokyo (JP)

(72) Inventors: Isao Imamura, Kawasaki-shi (JP); Yoshiyuki Shino, Yokohama-shi (JP); Shogo Kawamura, Kawasaki-shi (JP)

(21) Appl. No.: 14/553,019

(22) Filed: Nov. 25, 2014

(30) Foreign Application Priority Data
Dec. 20, 2013 (JP) 2013-263908
Nov. 7, 2014 (JP) 2014-226868

(51) Int. Cl. B29C 45/00; B41J 2/16

(52) U.S. Cl. CPC B29C 45/0001; B41J 2/1637; B41J 2/1623; B29K 2063/00

(57) ABSTRACT

The present invention provides a resin molding method that can produce a molded product that is inexpensive and represents a small linear expansion coefficient, a high degree of resistance to various liquids and an excellent mold releasability as well as a high degree of dimensional accuracy. The resin molding method includes a step of plasticizing thermosetting resin (S2) and injecting the plasticized thermosetting resin into the cavity of a metal mold apparatus (S3), a step of curing the thermosetting resin in the cavity (S4) and a step of opening the mold (S5). The step of opening the mold (S5) is executed when the mold that forms the cavity is at a temperature not lower than the glass transition point Tg of the thermosetting resin.

### BACKGROUND OF THE INVENTION

1. Field of the Invention

The present invention relates to a resin molding method and a liquid ejection head manufacturing method.

2. Description of the Related Art

Some parts of liquid ejection heads such as base plates that require a high degree of dimensional accuracy are formed by means of metal or ceramic (e.g., alumina) in certain instances. Parts can be formed to represent a high degree of dimensional accuracy with ease by means of ceramic materials such as alumina, which are additionally highly resistant to liquids such as ink. However, alumina is expensive and hence raises the manufacturing cost of the products that are formed by using alumina.

Thus, Japanese Patent Application Laid-Open No. 2009-155370 proposes a technique of molding parts of motors to be used for driving vehicles by using an epoxy resin molding material containing epoxy resin, an epoxy resin curing agent, a curing accelerator, an inorganic filler, silicon resin, thermosetting resin, and a silane coupling agent.

The epoxy resin molding material described in Japanese Patent Application Laid-Open No. 2009-155370 is less expensive than alumina and represents a small linear expansion coefficient because the proposed material contains a filter to a large extent. Therefore, the material is less likely to significantly expand to give rise to stress and deformation in a state where the material is bonded to some other member. Like other thermosetting resin materials, the epoxy resin molding material is injected into the cavity of a metal mold apparatus for molding and, when the mold is opened in a later step, the material has already been cured to represent a high elastic modulus. Such molded product may adhere to the inner surface of the mold so that the mold may not be opened smoothly with ease in some instances because of the high elastic modulus they represent. If the molded product cannot smoothly and soundly be released from the mold (for mold releasing) after the molding process, the molded product may be cracked and rejected as defective molded product particularly when the molded product has a micro structure.

In view of the above-identified problem, therefore, the object of the present invention is to provide a resin molding method that can produce molded products that are inexpensive and can smoothly and soundly be released from the mold (for mold releasing) and a liquid ejection head manufacturing method that utilizes the resin molding method.

### SUMMARY OF THE INVENTION

In an aspect of the present invention, the above object is achieved by providing a resin molding method including: a step of plasticizing thermosetting resin and injecting the plasticized thermosetting resin into the cavity of a metal mold apparatus; a step of curing the thermosetting resin in the cavity; and a step of opening the mold.

The step of opening the mold is executed when the mold having the cavity is at a temperature not lower than the glass transition point of the thermosetting resin.

With this method, since the mold is opened at a temperature not lower than the glass transition point of the thermosetting resin and hence in a state where the molded product can easily be elastically deformed, the molded product is made to come off from the mold little by little while the product is elastically deformed. Therefore, if compared with an instance where a part of a molded product having a broad surface comes off from a mold at a time, the method of the present invention provides an improved mold releasing effect.

Further features of the present invention will become apparent from the following description of exemplary embodiments with reference to the attached drawings.

### BRIEF DESCRIPTION OF THE DRAWINGS

FIGS. 1A, 1B and 1C are a schematic exemplary illustration of the resin molding method according to the present invention.

FIG. 2 is a flowchart of the resin molding method illustrated in FIGS. 1A, 1B and 1C.

FIGS. 3A and 3B are respectively a lateral view and a bottom view of a liquid ejection head including a base plate that is molded by the resin molding method illustrated in FIGS. 1A, 1B, 1C and FIG. 2.

FIG. 4 is an exploded schematic perspective view of the liquid ejection head illustrated in FIGS. 3A and 3B.

FIG. 5 is an enlarged schematic cross sectional view of one of the element substrates of the liquid ejection head illustrated in FIGS. 3A, 3B and FIG. 4.

FIG. 6 is an enlarged schematic cross-sectional view of two molds illustrating an instance where the draft angles of two molds are made to be different from each other.

### DESCRIPTION OF THE EMBODIMENTS

Now, the present invention will be described further by referring to the accompanying drawings that illustrate embodiments of the invention.

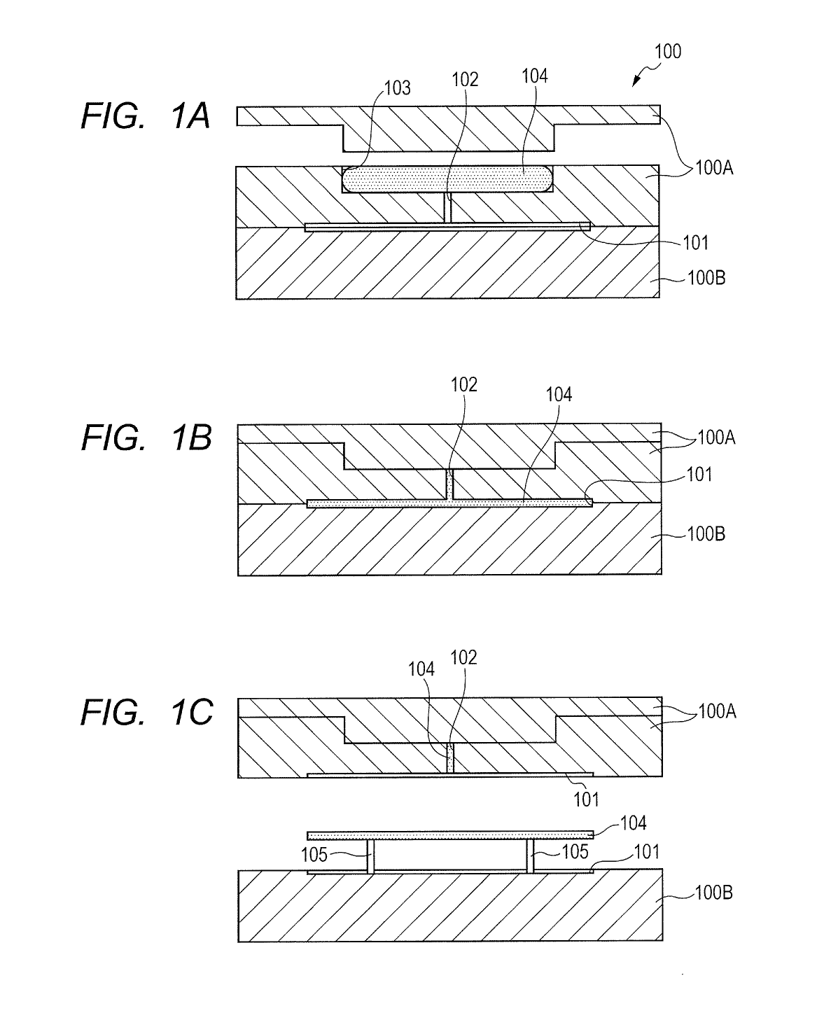

An exemplary embodiment of thermosetting resin molding method according to the present invention employs a metal mold apparatus 100 as illustrated in FIGS. 1A through 1C for transfer molding. More specifically, the metal mold apparatus 100 includes two molds, mold 100A and mold 100B, that are disposed oppositely relative to each other. The two molds 100A and 100B are contactable and separable. In other words, they can be brought into contact with each other and separated from each other. When the two molds 100A and 100B are brought into contact with each other (and hence into a closed state of the metal mold apparatus), a cavity 101 that represents a profile same as the profile of an intended molded product is produced between them. The metal mold apparatus 100 is provided with a heating chamber (also referred to as pot or chamber) 103 that communicates with the cavity 101 by way of resin flow path (runner and gate) 102.

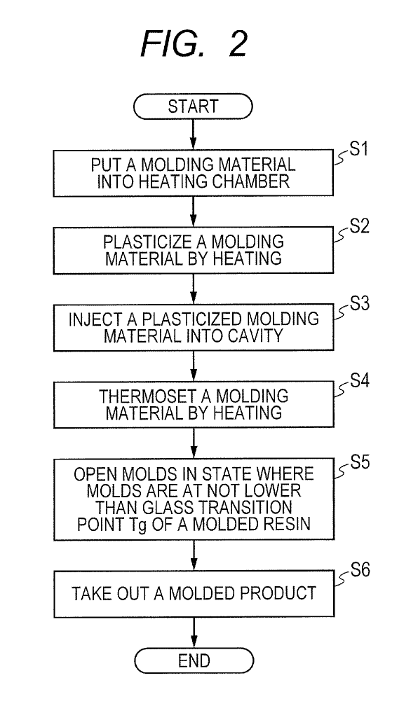

With this embodiment, the metal mold apparatus 100 is employed for transfer molding, using thermosetting resin, which may typically be epoxy resin, as molding material. As illustrated in the flowchart of FIG. 2, firstly epoxy resin 104 is put into the heating chamber 103 by an amount necessary for a single molding operation, the epoxy resin 104 being provided in the form of solid pellets, solid tablets or the like (Step S1, see FIG. 1A). Then, the epoxy resin 104 is heated in the heating chamber 103 for plasticization (Step S2). The plasticized epoxy resin 104 is taken out from the heating chamber 103 and injected into the cavity by way of the resin flow path 102 (Step S3, see FIG. 1B). The epoxy resin 104 is further heated in the cavity 101 to cause a crosslinking reaction to take place and cure the epoxy resin (Step S4). As the epoxy resin 104 cures, the molds 100A and 100B are opened in a state where the molds 100A and 100B are held to a temperature not lower than the glass transition point Tg of the epoxy resin 104 (Step S5). At this time, eject pins 105 are pushed out of the mold 100B to take out the molded product of the epoxy resin 104 from the cavity 101 (Step S6, see FIG. 1C). With this embodiment, a resin molding operation is conducted in the above-described manner.

Glass transition point Tg is the temperature found between the solid elasticity area and the rubber elasticity area of resin, which is the temperature range in which resin is in a dynamic viscoelasticity state, and at which the loss coefficient tan 5, which is the ratio of the storage elastic modulus E′ to the loss elastic modulus E″, represents the peak value.

Epoxy resin represents an excellent heat resistant property and an excellent chemical resistant property and hence is hardly eluted if brought into contact with liquid such as ink. Additionally, epoxy resin has an advantage of representing a relatively small linear expansion coefficient and hence has a small cure contraction coefficient. Furthermore, epoxy resin is a highly adhesive material and hence is mainly used in adhesive agents. Since materials representing a small linear expansion coefficient normally have a high glass transition point, such a material is conventionally molded in a condition where the mold temperature is lower than the glass transition temperature. Then, therefore, the mold is opened and the molded product is taken out in the solid elasticity area. At this time, namely after the molding process, however, the molded product cannot satisfactorily be released from the mold (mold releasing) because of the high adhesiveness and the high elastic modulus of epoxy resin. In other words, the molded product adheres to the mold at the time of opening the mold and hence cannot be taken out smoothly and soundly from the mold. Then, in certain instances, the molded product can be cracked or otherwise become defective.

To the contrary, with this embodiment, the timing of opening the mold is ingeniously planned, while maintaining the advantages of epoxy resin including that epoxy resin is hardly eluted and represents a high elastic modulus and a small linear expansion coefficient. More specifically, after the molding process, the molds 100A and 100B are opened in a state where the molds 100A and 100B are held to a temperature not lower than the glass transition point Tg so that the molded product 104 can be released from the mold smoothly and soundly (mold releasing). Additionally, a molded product that represents a high degree of dimensional accuracy can be produced highly efficiently with ease. The storage elastic modulus E′ of epoxy resin or some other similar resin material at the glass transition point Tg is generally not greater than about ½ to 1/10 of the storage elastic modulus E″ of the resin at room temperature. In other words, the resin material is in a state of being elastically deformed with ease at the glass transition point Tg. Therefore, when the mold is opened at a temperature not lower than the glass transition point, any part of the molded product 104 that has a relatively broad surface would not come off from the mold at a time but comes off gradually step by step while the molded product is deformed to a certain extent. In other words, the linear part comes off from the mold gradually and sequentially so that consequently the molded product can be released from the mold with ease. When the mold is opened at a higher temperature where the molded product is in the rubber elasticity area and the storage elastic modulus E′ is at the lowest level, the resin is more easily elastically deformed to further improve the mold releasing effect. Then, as a result, the degradation, if any, of the dimensional accuracy of the molded product 104 is effectively suppressed.

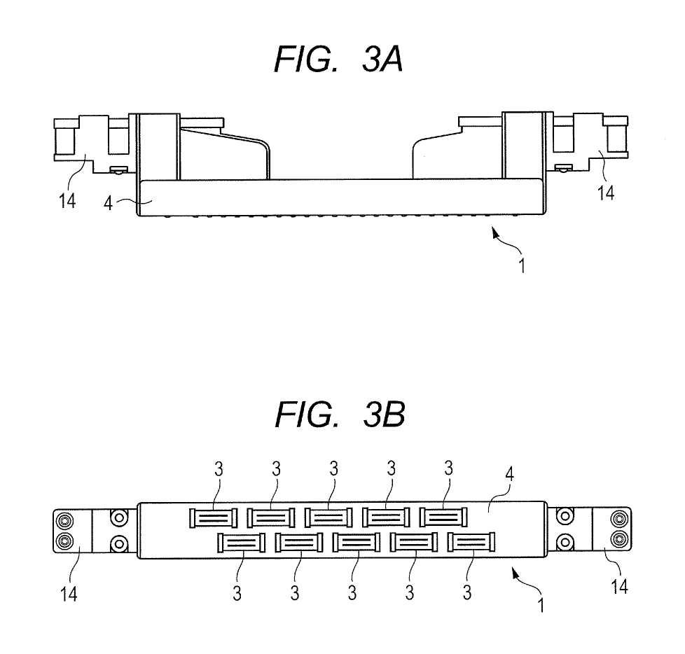

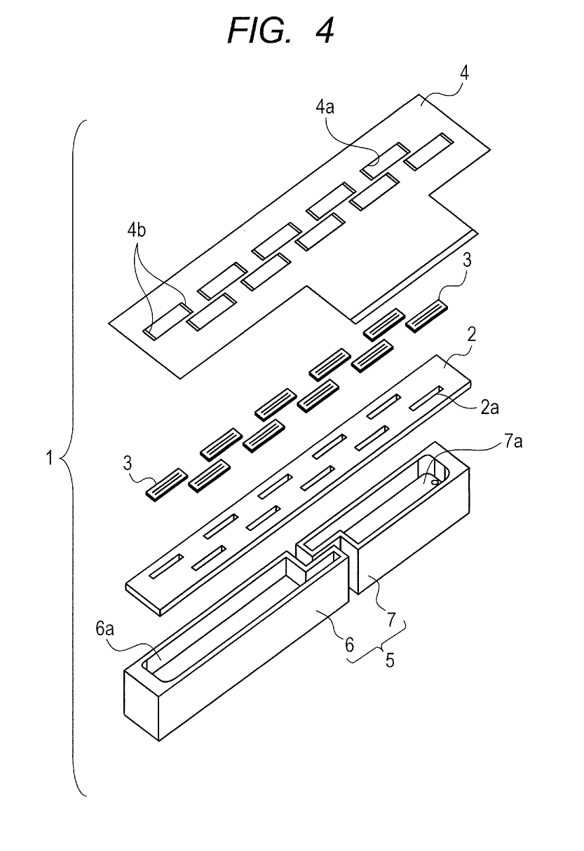

Now, a mode of application of a molded product molded by the above-described resin molding method, where the molded product is employed for a liquid ejection head for ejecting liquid such as ink, will be described below. As illustrated in FIGS. 3A, 3B and 4, in liquid ejection head 1, a plurality of element substrates 3 that are made of silicon are arranged on one of the opposite surfaces of an oblong base plate 2 in a zigzag manner in two rows running in a direction that intersects the direction along which recording mediums are to be conveyed. Additionally, an electric wiring substrate 4 is arranged above the element substrates 3. The electric wiring substrate 4 is a flexible print substrate and has a plurality of hole sections 4a for exposing the respective element substrates and connecting sections 4b for electrically connecting the electric wiring substrate 4 to the element substrates 3. The other surface of the base plate 2 is bonded to a liquid supply member 5. The liquid supply member 5 is formed by using a pair of hollow members 6 and 7 having respective liquid storage sections 6a and 7a. The base plate 2 is bonded to the liquid supply member 5 so as to operate as common lid for closing the two liquid storage sections 6a and 7a and has through holes 2a formed at positions where the element substrates 3 are arranged respectively.

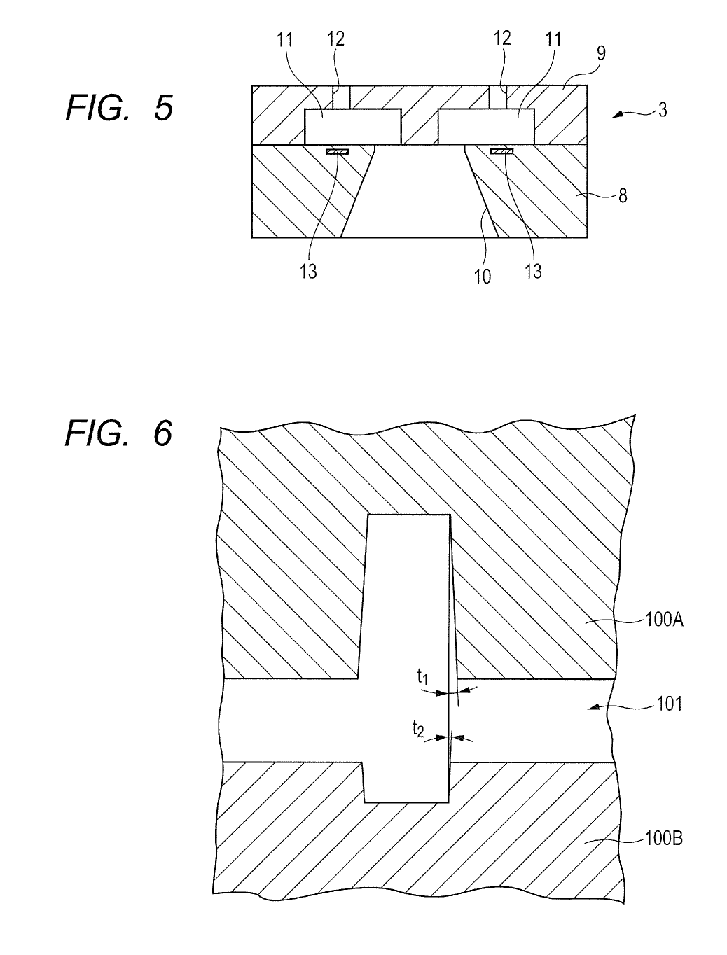

As illustrated in FIG. 5, each of the element substrates 3 has a layered structure that includes a substrate 8 and an ejection port forming member 9. Referring to FIG. 5, the substrate 8 is provided with a supply port 10 that is formed so as to communicate with the corresponding through hole 2a. The ejection port forming member 9 is provided with pressure chambers 11 and ejection ports 12 that communicate with the respective pressure chambers 11 and are open to the outside. In the substrate 8, ejection energy generating elements, which may typically be so many heat generating resistors 13, are arranged at positions that correspond to the respective pressure chambers 11. Thus, liquid that is supplied from a liquid tank (not illustrated) to the liquid storage sections 6a and 7a of the liquid supply member 5 flows into the pressure chambers 11 from the through holes 2a of the base plate 2 by way of the corresponding supply ports 10.

As an electric signal transmitted from a control circuit (not illustrated) to the element substrates 3 by way of the connecting sections 4b of the electric wiring substrate 4 is supplied to the heat generating resistors 13 by way of electric wiring (not illustrated), the heat generating resistors 13 are driven to generate heat. Then, the liquid in the pressure chambers 11 to which heat is applied as ejection energy bubbles and is ejected to the outside from the ejection ports 12 under the pressure of bubbles. If, for example, the liquid is ink, the ink ejected from the ejection ports 12 as described above adheres to the recording medium (not illustrated) placed at a position that faces the liquid ejection head 1 to form one or more than one characters and/or images on the recording medium. The liquid ejection head 1 illustrated in FIGS. 3A, 3B and 4 is a full line type head that has rows of ejection ports having a length greater than the width of the recording medium and hence can eject liquid over a broad area without any scanning operation. The liquid ejection head 1 is rigidly secured to a cabinet (not illustrated) by means of holding sections 14 illustrated in FIGS. 3A and 3B.

In general, the element substrates 3 of a liquid ejection head 1 having the above-described configuration are formed by applying a micro machining technique, which may typically be the so-called Micro Electro Mechanical (MEM) Technology onto a silicon-made substrate. Minute ejection ports 12 are highly densely arranged in liquid ejection heads 1 including those that have been fabricated in recent years and those that are being fabricated currently for the purpose of high speed and high definition recording. Therefore, the element substrates 3 and the base plate 2 that is a support member for supporting the element substrates 3 are required to represent a high degree of dimensional accuracy and also a high degree of flatness in order to realize high quality recording.

Particularly, in the case of a long liquid ejection head 1 having a length that corresponds to the length of the recording mediums to be used for the liquid ejection head 1 as illustrated in FIGS. 3A, 3B and 4, the base plate 2 and/or some or all of the element substrates 3 can become warped or otherwise deformed and stress can be produced between the base plate 2 and the element substrates 3 to give rise to distortions if the base plate 2 and the element substrates 3 represent a difference of thermal expansion that is greater than a predetermined level. Then, the reliability of the adhesion of the base plate 2 and the element substrates 3 can fall and other adverse effects can arise. Therefore, desirably the base plate 2 and the element substrates 3 represent only a small difference, if any, of linear expansion so that stress may not be produced excessively between them and hence the base plate 2 represents a small linear expansion coefficient. Additionally, the base plate 2 has areas that are brought into contact with liquid (ink) and hence, if the material of the base plate 2 is eluted into ink only by several ppm, ink can evaporate at and near some or all of the ejection ports 12 and evaporation deposits can adhere to them. Then, in such an instance, liquid droplets can be deviated by the deposits to by turn give rise to defective ejections and otherwise degrade the ejection performance of the liquid ejection head 1. Then, some of the ejection ports 12 may be clogged by such deposits so that the liquid ejection head 1 may ultimately become unable to eject liquid. Therefore, the base plate 2 is desired to represent a high degree of chemical resistance (at least a high degree of resistance to the ink to be used with the liquid ejection head 1).

From this point of view, epoxy resin is highly suitable as the material of the base plate 2 of the liquid ejection head 1 because epoxy resin represents a high degree of heat resistance and chemical resistance and has a small linear expansion coefficient. Note, however, epoxy resin is a material that is highly adhesive and hence cannot be released from the mold with ease after a molded product is produced, as pointed out earlier. For this reason, to date, the use of epoxy resin for producing molded products can entail a poor efficiency of molding operations and a low degree of dimensional accuracy.

To eliminate the above-identified problem, the liquid ejection head manufacturing method of this embodiment includes forming a base plate 2 by means of the above-described resin molding method and bonding a plurality of element substrates 3 onto the base plate 2. More specifically, with this embodiment, the timing of opening the mold is ingeniously planned for molding a base plate 2 in order to improve the mold releasability after the molding process, while maintaining the above-listed advantages of epoxy resin. In other words, the mold is opened before the molded product is fully cooled after the molding operation, more specifically, in a state where the epoxy resin in the mold is at a temperature not lower than the glass transition point and hence before the epoxy resin gets into the solid elasticity area. Then, as a result, the molded product can be released from the mold with ease, while the product is being elastically deformed. Thus, the efficiency of the molding operation is improved and a molded product that represents a high degree of dimensional accuracy can be obtained.

### EXAMPLES

Now, the present invention will be described further by way of specific examples and comparative examples, the latter being set forth for the purpose of comparison.

The composition of the molding material 104 used in Examples and Comparative Examples in this specification is represented below.
Epoxy Resin (jER Cure 828EL: trade name, available from Mitsubishi Chemical Corporation): 95 weight portions
Imidazole (jER Cure EMI24: trade name, available from Mitsubishi Chemical Corporation): 4 weight portions
Silane Coupling Agent (OSILQUEST A-187 SILANE: trade name, available from Momentive Performance Materials Japan LLC): 5 weight portions
Rheology Control Agent (BYK-410: trade name, available from BIGCHEMIE Japan Co.): 0.5 weight portions
High Molecular Weight Wetting and Dispersing Additive (DISPERBYK-145: trade name, available from BIGCHEMIE Japan Co.): 0.5 weight portions
Fused Silica (FB-950: trade name, available from DENKIKAGAKU KOGYOU): 800 weight portions
Fused Silica (FB-5D: trade name, available from DENKIKAGAKU KOGYOU): 100 weight portions

The molding material (epoxy resin) 104 does not contain any internal mold releasing agents such as wax and/or fatty acid metal salt. Instead, a mold releasing agent for secondary processing (MS-600: trade name, available from Daikin Industries, Ltd.) is blown onto the inner surface of the cavity 101 of the molds 100A and 100B of the metal mold apparatus 100 and wiped so as to eliminate unevenness of the blown agent.

The molding material 104 was heated at 150° C. for 4 hours and further at 180° C. for 1.5 hours for thermosetting. Then, that no reaction heat had been generated and the cross linking reaction had been completed was confirmed by differential scanning calorimetry (DSC). Thereafter, the dynamic viscoelasticity of the molding material 104 was measured by means of a dynamic viscoelasticity measuring instrument (DMS6100: trade name, available from SII Nanotechnology Inc.). As a result, the molding material 104 proved that the storage elastic modulus E′ thereof abruptly falls from about 140° C. while the glass transition point Tg thereof (the temperature at which tang δ is at the peak) is 170° C. and the material gets into the rubber elasticity area at 190° C. and higher.

The molding material 104 was mixed and kneaded in a planetary mixer to bring the material into a clay-like state. Then, the molding material that is in a clay-like state is arranged in a heating chamber as illustrated in FIG. 1A and heated for plasticization. The duration of the heating operation (injection start standby time period) was 10 seconds in the examples of this invention (but the molding material 104 was preliminarily heated by means of a microwave prior to arranging the molding material 104 in the heating chamber 103). The molding material 104 that had been plasticized in the above-described manner was then injected into the cavity 101 by way of the resin flow path 102 and further heated to cause a crosslinking reaction to take place for thermosetting. The duration of the heating operation (curing time) was 75 seconds in the examples of this invention. After the molding material 104 was cured by thermosetting, the mold 100A was separated from the mold 100B to open the molds in a state where the temperature of the molds 100A and 100B was not lower than the glass transition point Tg (170° C.) of the molding material 104. Then, the molded product 104 was taken out from the mold 100B.

With the above-described molding method, the molds were opened in a state where both of the molds 100A and 100B were at 190° C. in Example 1 and the molds were opened in a state where the mold 100A was at 200° C. and the mold 100B was at 190° C. in Example 2, while the molds were opened in a state where both of the molds 100A and 100B were at 170° C. in Example 3. As a result, the molded product was released in an excellent manner (to represent an excellent mold releasing effect) in each of Examples 1 through 3 and the molded products 104 were free from degradation of dimensional accuracy (Table 1). This was because, when the molding material (epoxy resin) 104 was at a temperature not lower than the glass transition point Tg of the material, the molding material 104 represents a low elastic modulus so that the molding material 104 is easily elastically deformed at the time of being released from the mold 100A and hence the force trying to move the molding material 104 away from the mold 100A was localized and hence acted efficiently. Particularly, the molds were opened in a state where the molding material 104 was in the rubber elasticity area in each of Examples 1 and 2 so that the molding material 104 was easily elastically deformed to further improve the effect of being released from the mold.

TABLE 1

| | Example | | | Comparative Example | | | | |
|---|---|---|---|---|---|---|---|---|
| | 1 | 2 | 3 | 1 | 2 | 3 | 4 | 5 |
| Upper mold | 190 | 200 | 170 | 150 | 150 | 150 | 160 | 165 |
| temperature | | | | | | | | |
| (° C.) | | | | | | | | |
| Lower mold | 190 | 190 | 170 | 150 | 150 | 150 | 160 | 165 |
| temperature | | | | | | | | |
| (° C.) | | | | | | | | |
| Injection start | 10 | 10 | 10 | 0 | 5 | 10 | 10 | 10 |
| standby time | | | | | | | | |
| period | | | | | | | | |
| (seconds) | | | | | | | | |
| Curing time | 75 | 75 | 75 | 75 | 75 | 75 | 75 | 75 |
| (seconds) | | | | | | | | |
| Molding | ◯ | ◯ | ◯ | X | Δ | Δ | Δ | Δ |
| releasing effect | | | | | | | | |

◯: The molded product was smoothly released from the molds.
Δ: The molded product was caught by the molds but ultimately could be released from the molds.
X: The molded product could not be released from the molds.

As described above, the molds are preferably opened in a state where the molding material 104 is at a temperature not lower than the glass transition point Tg of the material (more preferably at a temperature where the molding material is put into the rubber elasticity area) to realize the advantages of the present invention. Note, however, that it is difficult to measure the temperature of the molding material 104 itself when the molding process is in progress and immediately after the molding process. However, this problem can be eliminated by measuring the temperature of the molds 100A and 100B for the molding operation because the measured temperature of the molds 100A and 100B can safely be regarded to be substantially equal to the temperature of the molding material 104 in the molds. The temperature of the molds 100A and 100B is preferably measured at or near the inner surface of the cavity 101.

To the contrary, no injection start standby time period, or no heating time for plasticizing the molding material 104, was provided prior to the actual operation of injecting the molding material 104 in Comparative Example 1. In other words, the molding material 104 was injected into the cavity 101 before the fluidity of the molding material 104 was improved. Then, the molding material 104 was heated for 75 seconds for thermosetting and the molds 100A and 100B were opened in a state where both the molds 100A and 100B were at 150° C., which is lower than the glass transition point Tg of the molding material 104 (epoxy resin), and the molded product 104 was taken out. Since the molding material 104 was pushed into the cavity 101 in a state where the molding material 104 showed a poor fluidity in Comparative Example 1, the soft mold releasing agent on the surfaces of the molds 100A and 100B was scraped and forced to come off by the filler in the molding material 104. Then, the molding material 104 that was adhering to the surfaces of the molds 100A and 100B from which the mold releasing agent had been lost would not be separated from the surfaces of the molds 100A and 100B and hence the molded product 104 could not be released from the molds.

In Comparative Example 2, an injection start standby time period of 5 seconds was provided prior to the injection of the molding material and the molding material was injected into the cavity and heated for 75 seconds for thermosetting. Subsequently, the molds 100A and 100B were opened in a state where the molding material was at 150° C., which was lower than the glass transition point Tg of the molding material, and the molded product was taken out. In each of Comparative Examples 3 through 5, an injection start standby time period of 10 seconds was provided for injection and the molding material 104 was injected into the cavity 101 and heated for 75 seconds for thermosetting as in Examples 1 through 3. Thereafter, the molds 100A and 100B were opened in a state where both of the molds 100A and 100B were at 150° C. in Comparative Example 3, in a state where both of the molds 100A and 100B were at 160° C. in Comparative Example 4 and in a state where both of the molds 100A and 100B were at 165° C. in Comparative Example 5 and then the molded products 104 were taken out. In each of Comparative Examples 2 through 5, the mold releasing agent on the surfaces of the molds 100A and 100B did not come off but a situation where the molded product 104 was gradually released from the molds 100A and 100B, while being deformed to a certain extent, could not be realized because the elastic modulus of the molding material 104 was high at the time of opening the molds and hence the molded product 104 could hardly be elastically deformed. In other words, because the molded product 104 could hardly be elastically deformed, the part of the molded product having a relatively broad surface area had to be separated from the molds 100A and 100B at a time and hence the molded product 104 could not be smoothly released from the mold 100B when the molded product 104 was pushed by the eject pins 105.

When compared with Comparative Examples 1 through 5, the molding material 104 of Examples 1 through 3 showed a small elastic modulus and hence could be elastically deformed so that the molded product 104 could be gradually separated from the molds 100A and 100B, while being deformed to a certain extent, to realize a smooth mold releasing effect.

The molding time is desirably short from the viewpoint of productivity. However, when the molding time is made too short, the reaction ratio of the molding material 104 itself falls and the molded product 104 can be plastically deformed and broken at the time of opening the molds so that a too short molding time is not desirable from the viewpoint of molding performance. Stated differently, the reaction ratio is preferably not less than 90%, more preferably not less than 93%, at the time of opening the molds. The reaction ratio was about 93% in Examples and Comparative Examples, which were described above. The reaction ratio is expressed by the formula represent below.

Reaction Ratio=(calorific value of material before molding−calorific value of material after molding)/(calorific value of material before molding)×100

In Examples and Comparative Examples, the calorific values were measured by means of a differential scanning calorimeter (DSC822: trade name, available from Mettler Toledo International Inc.).

When the surface area of the molded product 104 that is in contact with the mold 100A differs from the surface area of the product 104 that is in contact with mold 100B, the molded product 104 can adhere to the mold with which the lager surface area of the product is in contact to give rise to a problem of imperfect mold releasing. To prevent such an imperfect mold releasing problem from taking place, preferably the draft angle (draft taper) of the mold having a larger contact area is made large and the draft angle of the mold having a smaller contact area is made small. For example, when the upper mold 100A has a contact area of being in contact with the molded product that is larger than the contact area of the lower mold 100B as schematically illustrated in FIG. 6, the upper mold 100A and the lower mold 100B are so designed that the draft angle t1 of the upper mold 100A is larger than the draft angle t2 of the lower mold 100B. Then, as a result, the fall, if any, of the mold releasing performance ban be prevented from taking place.

The composition of molding material that can be used for the purpose of the present invention is not limited to the above-described one. In other words, various different epoxy resin molding materials can be used for the present invention so long as the material represents a small linear expansion coefficient and a small cure contraction coefficient. Furthermore, thermosetting resin molding materials other than epoxy resin molding materials can also be used for the purpose of the present invention. Thermosetting resin molding materials that can be used for the present invention may contain one or more than one internal mold releasing agents of any types (e.g., wax) that do not give rise to elution if contained to a large content ratio.

The present invention can be applied not only to molding of parts of liquid ejection heads 1 (including base plates 2 and element substrates 3) but also to production of any molded products. The present invention is particularly very effective when it is utilized to form parts that should maximally prevent elution of the material into liquid such as parts of water purification apparatus and water purification systems, food manufacturing apparatus, medical apparatus, etc.

According to the present invention, as described above, molded products of materials representing a small linear expansion coefficient and also a small cure contraction coefficient can be released from the mold with ease after the molding process. Even molded products of thermosetting materials that do not contain any mold releasing agent can be released from the mold with ease when the molds are subjected to a mold releasing treatment.

Thus, according to the present invention, the mold releasing effect can be improved for molded products by specifying the timing of opening the molds after the completion of the molding process so that the operation of opening the molds does not entail any degradation of the dimensional accuracy of the molded product. Therefore, a molded product that represents a high degree of dimensional accuracy can be produced efficiently with ease. Thus, the present invention is very effective particularly for forming members such as base plates of liquid ejection heads that require a high degree of dimensional accuracy and, at the same time, satisfying various requirements including a requirement of a low linear expansion coefficient and a requirement of hardly allowing elution.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-263908, filed Dec. 20, 2013, and Japanese Patent Application No. 2014-226868, filed Nov. 7, 2014 which are hereby incorporated by reference herein in their entirety.

What is claimed is:

1. A resin molding method comprising:
a step of plasticizing thermosetting resin and injecting the plasticized thermosetting resin into the cavity of a metal mold apparatus;
a step of curing the thermosetting resin in the cavity; and
a step of opening the mold forming the cavity when the mold is at a temperature not lower than the glass transition point of the thermosetting resin.

2. The method according to claim 1, wherein
the step of opening the mold is executed when the mold is at the temperature where the thermosetting resin gets into the rubber elasticity area.

3. The method according to claim 1, wherein
the thermosetting resin is epoxy resin.

4. The method according to claim 1, wherein
in the step of injecting the thermosetting resin into the cavity, the thermosetting resin that has been heated in a heating chamber and plasticized is injected into the cavity for transfer molding by way of the resin flow path arranged in the mold in a state where the mold is closed.

5. The method according to claim 1, wherein
the thermosetting resin does not contain any internal mold releasing agent.

6. The method according to claim 1, wherein
the thermosetting resin does not contain any fatty acid metal salt.

7. The method according to claim 1, wherein
the cavity is formed at least by two molds that are arranged face to face so as to be contactable and separable and the draft angle between one of the molds and the molded product of the thermosetting resin differs from the draft angle between the other mold and the molded product.

8. The method according to claim 7, wherein
the draft angle of the mold that has a larger contact area with the molded product is greater than the draft angle of the other mold that has a smaller contact area with the molded product.

9. A method of manufacturing a liquid ejection head having a base plate and an element substrate laid on the base plate, the element substrate being provided with an ejection energy generating element and an ejection port, the liquid ejection head being adapted to eject the liquid supplied to the element substrate from the ejection port to the outside by applying ejection energy from the ejection energy generating element to the liquid, the method comprising:
forming the base plate by the method according to claim 1; and
bonding the element substrate onto the base plate.

10. The method according to claim 9, wherein
a plurality of element substrates are bonded onto a single base plate.

11. A liquid ejection head manufacturing method comprising:
a step of plasticizing epoxy resin and injecting the epoxy resin into the cavity of a metal mold apparatus;
a step of curing the epoxy resin in the cavity;
a step of opening the mold forming the cavity and taking out the support member that is the molded product when the mold is at a temperature not lower than the glass transition point of the epoxy resin; and
bonding a plurality of element substrates, each having an ejection energy generating element for generating energy to be utilized to eject liquid, onto the support member.

12. The method according to claim 11, wherein
the step of opening the mold is executed when the mold is at the temperature where the thermosetting resin gets into the rubber elasticity area.

13. The method according to claim 11, wherein
the epoxy resin contains a filler.

14. The method according to claim 11, wherein
in the step of injecting the epoxy resin into the cavity, the epoxy resin that has been heated in a heating chamber and plasticized is injected into the cavity for transfer molding by way of the resin flow path arranged in the mold in a state where the mold is closed.

15. The method according to claim 11, wherein
the epoxy resin does not contain any internal mold releasing agent.

16. The method according to claim 11, wherein
the epoxy resin does not contain any fatty acid metal salt.

17. The method according to claim 11, wherein
the cavity is formed at least by two molds that are arranged face to face so as to be contactable and separable and the draft angle between one of the molds and the molded product of the thermosetting resin differs from the draft angle between the other mold and the molded product.
